(19) United States
(12) Patent Application Publication
(10) Pub. No.: US 2025/0037419 A1
(43) Pub. Date: Jan. 30, 2025

(54) OBJECT RECOGNITION DEVICE AND OBJECT RECOGNITION METHOD

(71) Applicant: Acer Incorporated, New Taipei City (TW)

(72) Inventor: Sergio Cantero Clares, New Taipei City (TW)

(73) Assignee: Acer Incorporated, New Taipei City (TW)

(21) Appl. No.: 18/360,823

(22) Filed: Jul. 28, 2023

(51) Int. Cl. G06V 10/70; G06F 3/01; G06T 11/60; G06V 10/25; G06V 30/224

(52) U.S. Cl. CPC G06V 10/70; G06F 3/013; G06T 11/60; G06V 10/25; G06V 30/2247; G06T 2200/24

(57) ABSTRACT

An object recognition device and an object recognition method are provided. The object recognition method includes: receiving a first image and receiving a user input; detecting an object of the first image to obtain a detection region and an object class; in response to the user input matching the detection region, generating a recognition result of the object through a first machine learning model corresponding to the object class; and outputting information corresponding to the recognition result.

### BACKGROUND

### Technical Field

The disclosure is directed to an object recognition device and an object recognition method.

### Description of Related Art

Object recognition is a technique to locate and identify objects present in an image. Since an image may include random objects, an object recognition model for images should be able to recognize different kinds of objects. However, the recognition result generated by such object recognition model may lack a lot of detailed information. For example, an object recognition model trained for various object classes may only be able to locate a person in an image, while an object recognition model dedicated for face recognition may identify the identity of the person in the image. Therefore, how to provide a method that can identify various object classes accurately is one of the important issues in the field.

### SUMMARY

The disclosure is directed to an object recognition device and an object recognition method by which detailed information of objects in the image is recognized accurately.

An object recognition device of the present invention including a first transceiver, an input device, an output device, and a processor. The first transceiver receives a first image. The input device receives a user input. The processor is coupled to the input device, the output device, and the first transceiver and configured to: detect an object of the first image to obtain a detection region and an object class; in response to the user input matching the detection region, generating a recognition result of the object through a first machine learning model corresponding to the object class; and output information corresponding to the recognition result through the output device.

In one embodiment of present invention, the input device includes an image capturing device and the processor is further configured to: obtain a second image through the image capturing device; and perform eye tracking on the second image to obtain the user input.

In one embodiment of present invention, the object recognition device further including a sound capturing device coupled to the processor and obtains an audio signal, wherein the processor generates the recognition result through the first machine learning model in response to the audio signal.

In one embodiment of present invention, the output device includes a display device, and the processor is further configured to: display a graphical user interface through the output device, wherein the graphical user interface includes the information, wherein the information comprises at least one of description information of the object, a person's profile, summary information, or a representative drawing.

In one embodiment of present invention, the output device includes a second transceiver, and the processor is further configured to: transmitting an access command corresponding to the information through the output device.

In one embodiment of present invention, the output device includes a display device displaying the first image, wherein the processor is further configured to: in response to the user input matching the detection region, highlight the object of the first image through the display device.

In one embodiment of present invention, the processor is further configured to: access an external database through the first transceiver; and obtaining the information from the external database according to the recognition result.

In one embodiment of present invention, the object recognition device further including a storage medium coupled to the processor and stores a database, wherein the processor is further configured to: obtaining the information from the database according to the recognition result.

In one embodiment of present invention, the object recognition device further including a storage medium coupled to the processor and stores a plurality of machine learning models, wherein the plurality of machine learning models includes the first machine learning model, wherein the processor selects the first machine learning model from the plurality of machine learning models according to the object class and generates the recognition result according to the selected first machine learning model.

In one embodiment of present invention, the first machine learning model includes a You Only Look One (YOLO) model.

In one embodiment of present invention, the processor is further configured to: detect the object of the first image through an object detection model to obtain the detection region and the object class.

In one embodiment of present invention, the object class includes one of the followings: an identification of the object, a text, a two-dimensional barcode, or a product.

An object recognition method of the present invention including: receiving a first image and receiving a user input; detecting an object of the first image to obtain a detection region and an object class; in response to the user input matching the detection region, generating a recognition result of the object through a first machine learning model corresponding to the object class; and outputting information corresponding to the recognition result.

Based on the above, the object recognition device of the present invention may only generate the detailed information of the object of the image which the user is interested in. Therefore, a lot of computing resources for the object recognition can be saved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of an object recognition device according to one embodiment of the present invention.

FIG. 2 illustrates a flowchart of an object recognition method according to one embodiment of the present invention.

FIG. 3 illustrates a schematic diagram of an image according to one embodiment of the present invention.

FIG. 4 illustrates a flowchart of an object recognition method according to one embodiment of the present invention.

### DESCRIPTION OF THE EMBODIMENTS

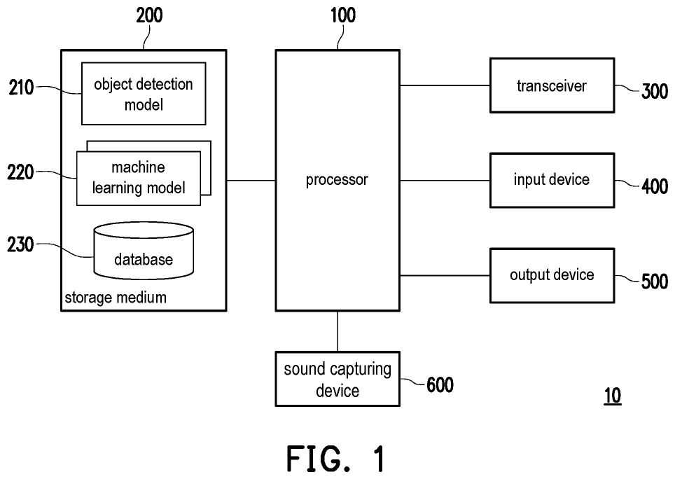

FIG. 1 illustrates a schematic diagram of an object recognition device 10 according to one embodiment of the present invention. The object recognition device 10 may include a processor 100, a storage medium 200, a transceiver 300, an input device 400, an output device 500, and a sound capturing device 600. The processor 100 may connect to the storage medium 200, the transceiver 300, the input device 400, the output device 500, and the sound capturing device 600.

The processor 100 is, for example, a central processing unit (CPU), or another programmable general-purpose or special-purpose microprocessor, a digital signal processor (DSP), a programmable controller, an application specific integrated circuit (ASIC), a graphics processing unit (GPU) or other similar elements, or a combination thereof. The processor 100 is capable of accessing and executing various modules or applications stored in the storage medium 200 to perform the functions of the object recognition device 10.

The storage medium 200 is, for example, any type of fixed or removable random access memory (RAM), a read-only memory (ROM), a flash memory, a hard disk drive (HDD), a solid state drive (SSD) or similar element, or a combination thereof, configured to record a plurality of modules or applications executable by the processor 100. In the present embodiment, the storage medium 200 may store an object detection model 210, one or more machine learning models 220, and a database 230.

The transceiver 300 transmits or receives signals wirelessly or wiredly. The transceiver 300 may also perform operations such as low noise amplifying (LNA), impedance matching, frequency mixing, up-down frequency conversion, filtering, amplification, and similar operations.

The input device 400 may be manipulated by a user to receive user input. In one embodiment, the input device 400 may include an image capturing device, wherein the image capturing device may include an image sensor such as a complementary metal oxide semiconductor (CMOS) or a charge coupled device (CCD).

The output device 500 may output information such as an image, a signal, or a sound for the user. In one embodiment, the output device 500 may include a display device or a transceiver. The display device includes, for example, a liquid-crystal display (LCD), a light-emitting diode (LED) display, a vacuum fluorescent display (VFD), a plasma display panel (PDP), an organic light-emitting diode (OLED), or a field-emission display (FED).

The sound capturing device 600 is, for example, a condenser microphone, an electret condenser microphone (ECM), or a micro-electro-mechanical system (MEMS) microphone.

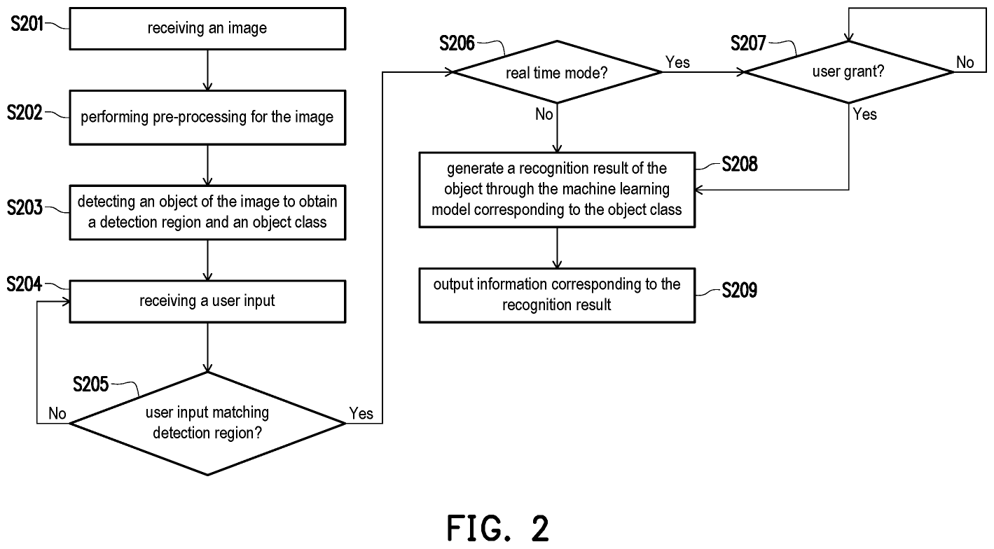

FIG. 2 illustrates a flowchart of an object recognition method according to one embodiment of the present invention, wherein the object recognition method may be implemented by the object recognition device 10 as shown in FIG. 1.

In the step S201, the processor 100 may receive an image to be recognized through the transceiver 300, wherein the image may be the image displayed by the output device 500. For example, said image may be a video of a basketball game currently watching by the user.

In the step S202, the processor 100 may perform pre-processing for the image, wherein the pre-processing may include but not limited to noise reduction, contrast enhancement, image resizing, color correction, segmentation, or feature extraction.

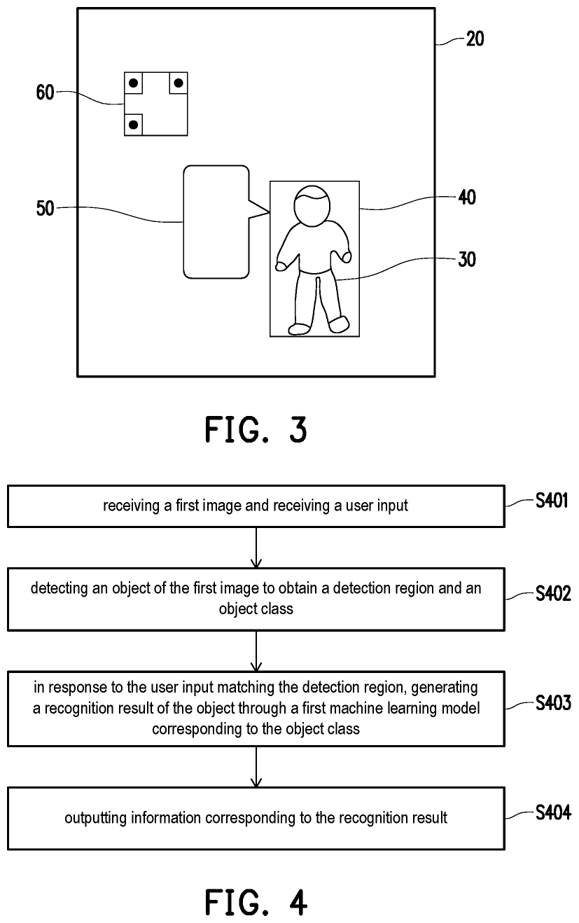

In the step S203, the processor 100 may detect an object of the image to obtain a detection region and an object class. The processor 100 may detect the object of the image through the object detection model 210 to obtain the detection region and the object class, wherein the detection region may represent the location of the object of the image. The object class may include but not limited to an identification of the object (e.g., a living organism such as a person, an animal, a plant, an insect, or bacteria), a text, a two-dimensional barcode (e.g., quick response (QR) code), or a product (e.g., a natural product such as a diamond or a pearl, or an artificial product such as a vehicle, a furniture, or a tool). In one embodiment, the object detection model 210 may include a machine learning model such as a convolution neural network (CNN) model. FIG. 3 illustrates a schematic diagram of an image according to one embodiment of the present invention. For example, the processor 100 may detect the object 30 in the image 20 to obtain the detection region and the object class of the object 30. Assuming the object 30 is a person (i.e., the object class of the object 30 is “person”), the processor 100 may obtain the detection region representing the location of the person in the image 20, wherein the detection region may be the region surrounded by the bounding box 40 generated by the object detection model 210. For another example, the processor 100 may detect the object 60 in the image 20 to obtain the detection region and the object class of the object 60. Assuming the object 60 is a two-dimensional barcode (i.e., the object class of the object 60 is “two-dimensional barcode”), the processor 100 may obtain the detection region representing the location of the two-dimensional barcode in the image 20.

Referring back to FIG. 2, in the step S204, the processor 100 may receive a user input through the input device 400. For example, assuming that the input device 400 is an image capturing device. The processor 100 may obtain an image of the user who is watching the image displayed by the output device 500. The processor 100 may perform eye tracking on the image of the user to obtain the user input, wherein the user input may be a gaze position of the user on the image displayed by the output device 500.

In the step S205, the processor 100 may determine whether the user input matches the detection region of the object (e.g., object 30 or object 60). That is, the processor 100 may determine whether the gaze position of the user is overlap with the detection region of the object (i.e., whether the user is gazing at the object on the image displayed by the output device 500). If the user input matches the detection region of the object (i.e., the user is gazing at the object), the processor 100 may determine that the detection region of the object is a region of interest (ROI) then proceed to the step S206. If the user input not matches the detection region of the object (i.e., the user is not gazing at the object), the processor 100 may execute the step S204 again.

In one embodiment, the processor 100 may highlight the object (e.g., object 30 or object 60) in the image 20 through the output device (i.e., a display device) 500 in response to the user input matching the detection region of the object. For example, the processor 100 may hide the bounding box 40 of the object 30 on the image 20 when the user is not gazing at the object 30. However, after the processor 100 determines that the user is gazing at the object 30, the processor 100 may show the bounding box 40 on the image 20 to highlight the object 30.

In the step S206, the processor 100 may determine whether the object recognition device 10 is in a real time mode. If the object recognition device 10 is in the real time mode, the processor 100 may proceed to the step S207. If the object recognition device 10 is not in the real time mode, the processor 100 may proceed to the step S208. In one embodiment, the object recognition device 10 may enter or leave the real time mode according to a configuration from the user. For example, the processor 100 may receive a user command through the transceiver 300 and determine to enter or leave the real time mode according to the user command.

In the step S207, the processor 100 may determine whether a user grant is received by the processor 100. If the user grant is received by the processor 100, the processor 100 may proceed to the step S207. If the user grant is not received by the processor 100, the processor 100 may execute the step S207 again to wait for the user grant. In one embodiment, the user grant may include an audio signal, wherein the processor 100 may obtain the audio signal through the sound capturing device 600. For example, if the processor 100 captures the sound of a sentence “showing the detailed information” spoken by the user, the processor 100 may determine that the user grant is received by the processor 100.

In the step S208, the processor 100 may generate a recognition result of the object (e.g., object 30 or object 60) through a machine learning model 220 corresponding to the object class of the object. Specifically, the storage medium 220 may store a plurality of machine learning models 220 trained for different object classes respectively. The processor 100 may select a machine learning model 220 from the plurality of machine learning models 220 according to the object class, and the processor 100 may generate the recognition result according to the selected machine learning model 220. For example, in response to determining that the object class of the object 30 is “person”, the processor 100 may select a machine learning model 220 trained for the object class “person” from the plurality of machine learning models 220, then the processor 100 may input the detection region of the object 30 into the selected machine learning model 220. The selected machine learning model 220 may output the recognition result of the object 30, wherein the recognition result of the object 30 may indicate an identity of a person. For another example, in response to determining that the object class of the object 60 is “two-dimensional barcode”, the processor 100 may select a machine learning model 220 trained for the object class “two-dimensional barcode” from the plurality of machine learning models 220, then the processor 100 may input the detection region of the object 60 into the selected machine learning model 220. The selected machine learning model 220 may output the recognition result of the object 60, wherein the recognition result of the object 60 may include a uniform resource locator (URL).

In one embodiment, the one or more machine learning model 220 stored in the storage medium 200 may include a You Only Look One (YOLO) model trained for performing, for example, face detection for a living organism, optical character recognition or semantic segmentation for a text, decoding for a two-dimensional barcode, or object recognition for a product.

In the step S209, the processor 100 may output information corresponding to the recognition result through the output device 500. In one embodiment, the information may pre-store in the database 230 in the storage medium 200 or in an external database (e.g., a cloud server). The processor 100 may access the database 230 or access the external database through the transceiver 300 to obtain the information corresponding to the recognition result. For example, the database 230 may pre-store a plurality of profiles of the people. After the processor 100 obtain the recognition result of the object 30 (i.e., an identity of a person), the processor 100 may query the database 230 to obtain a profile of a person corresponding to the recognition result or the object 30.

In one embodiment, the output device 500 may include a display device. The processor 100 may display a graphical user interface (GUI) through the output device 500, wherein the graphical user interface may include the information of the object such as description information of the object, a person's profile, summary information, or a representative drawing. Take FIG. 3 as an example, the processor 100 may display the graphical user interface 50 on the image 20, wherein the graphical user interface 50 may show the description information of the object 30. For example, if the object 30 is a basketball player, the graphical user interface 50 may show the stats of the player.

In one embodiment, the output device 500 may include a transceiver. The processor 100 may transmit an access command corresponding to the information of the object through the output device 500. Take FIG. 3 as an example, the processor 100 may transmit an access command corresponding to a URL through the output device 500 such that a website corresponding to the URL may be shown on the image 20, wherein the URL may be a decoding result of the object 60.

FIG. 4 illustrates a flowchart of an object recognition method according to one embodiment of the present invention, wherein the object recognition method may be implemented by the object recognition device 10 as shown in FIG. 1. In the step S401, receiving a first image and receiving a user input. In the step S402, detecting an object of the first image to obtain a detection region and an object class. In the step S403, in response to the user input matching the detection region, generating a recognition result of the object through a first machine learning model corresponding to the object class. In the step S404, outputting information corresponding to the recognition result.

Based on the above, the present invention may locate and recognize an object of an image by a two-phase mechanism. Firstly, the object recognition device of the present invention may detect the image through an object detection model to obtain the detection region and the object class of the object of the image. Then, the object recognition device may determine whether the user is interested in obtaining detailed information of the detected object. If the user is interested in obtaining the detailed information, the object recognition device may generate a recognition result of the object by a machine learning model. Since the machine learning model is only used for recognizing the object which the user is interested in, a lot of computing resources for the object recognition can be saved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An object recognition device, comprising:
a first transceiver, receiving a first image;
an input device, receiving a user input;
an output device; and
a processor, coupled to the input device, the output device, and the first transceiver and configured to:
detect an object of the first image to obtain a detection region and an object class;
in response to the user input matching the detection region, generating a recognition result of the object through a first machine learning model corresponding to the object class; and
output information corresponding to the recognition result through the output device.

2. The object recognition device according to claim 1, wherein the input device comprises an image capturing device and the processor is further configured to:
obtain a second image through the image capturing device; and
perform eye tracking on the second image to obtain the user input.

3. The object recognition device according to claim 1, further comprising:
a sound capturing device, coupled to the processor and obtains an audio signal, wherein
the processor generates the recognition result through the first machine learning model in response to the audio signal.

4. The object recognition device according to claim 1, wherein the output device comprises a display device, and the processor is further configured to:
display a graphical user interface through the output device, wherein the graphical user interface comprises the information, wherein the information comprises at least one of description information of the object, a person's profile, summary information, or a representative drawing.

5. The object recognition device according to claim 1, wherein the output device comprises a second transceiver, and the processor is further configured to:
transmit an access command corresponding to the information through the output device.

6. The object recognition device according to claim 1, wherein the output device comprises a display device displaying the first image, wherein the processor is further configured to:
in response to the user input matching the detection region, highlight the object of the first image through the display device.

7. The object recognition device according to claim 1, wherein the processor is further configured to:
access an external database through the first transceiver; and
obtain the information from the external database according to the recognition result.

8. The object recognition device according to claim 1, further comprising:
a storage medium, coupled to the processor and stores a database, wherein the processor is further configured to:
obtain the information from the database according to the recognition result.

9. The object recognition device according to claim 1, further comprising:
a storage medium, coupled to the processor and stores a plurality of machine learning models, wherein the plurality of machine learning models comprises the first machine learning model, wherein
the processor selects the first machine learning model from the plurality of machine learning models according to the object class and generates the recognition result according to the selected first machine learning model.

10. The object recognition device according to claim 1, wherein the first machine learning model comprises a You Only Look One (YOLO) model.

11. The object recognition device according to claim 1, wherein the processor is further configured to:
detect the object of the first image through an object detection model to obtain the detection region and the object class.

12. The object recognition device according to claim 1, wherein the object class comprises one of the followings: an identification of the object, a text, a two-dimensional barcode, or a product.

13. An object recognition method, comprising:
receiving a first image and receiving a user input;
detecting an object of the first image to obtain a detection region and an object class;
in response to the user input matching the detection region, generating a recognition result of the object through a first machine learning model corresponding to the object class; and
outputting information corresponding to the recognition result.
